(19) United States
(12) Patent Application Publication
(10) Pub. No.: US 2005/0213443 A1
(43) Pub. Date: Sep. 29, 2005

(54) Method for generating gain-adjusted tracking error signal

(75) Inventors: Jen-Yu Hsu, Hsinchu (TW); Ren-Chien Fu, Hsinchu (TW); Tun-Chieh Lee, Hsinchu (TW); Ying-Ta Lin, Hsinchu (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/080,779

(22) Filed: Mar. 15, 2005

(30) Foreign Application Priority Data
Mar. 24, 2004 (TW) 093107970

(51) Int. Cl. G11B 7/00

(52) U.S. Cl. 369/44.29

(57) ABSTRACT

A method for generating a gain-adjusted tracking error signal in a disc reading apparatus includes the following steps. Firstly, a disc having been defined with a data region and a blank region is loaded into the disc reading apparatus. Then, a start-up procedure is executed, and a seeking operation across an interface between the data region and the blank region is performed to detect first and second voltage peaks of a first tracking error signal for the data region and the blank region, respectively. After the start-up procedure has been completed, the disc reading apparatus enters a ready-to-read state. In the ready-to-read state, a tracking operation is performed to generate a second tracking error signal and the second tracking error signal is adjusted with a first gain and a second gain for the data region and the blank region, respectively, thereby generating the gain-adjusted tracking error signal. Specifically, the ratio of the first gain to the second gain is equal to the ratio of the second voltage peak to the first voltage peak.

### FIELD OF THE INVENTION

The present invention relates to a method for generating a gain-adjusted tracking error signal, and more particularly to a method for generating a tracking error signal adjusted with different gains for different regions of a disc.

### BACKGROUND OF THE INVENTION

Referring to FIG. 1, a schematic top view of an optical disc to be read by an optical disc drive is shown. The shaded portion 1101 indicates the data region of the optical disc 110 where data have been previously written, and the unshaded portion 1102 indicates the blank region of the optical disc 110 where only essential information is recorded and no data is written.

The optical disc, for example a compact disc (CD), video compact disc (VCD) or digital versatile disc (DVD), is able to be played by recording and reproducing apparatuses. When an optical pickup head of an optical disc drive operates, the light emitted by a light source such as a laser diode is focused by an object lens of the optical pickup head on an optical disc, and the light reflected by the optical disc is transmitted to a light sensor to realize information from the disc. The optical pickup head 10 moves along two main directions, i.e. a direction perpendicular to the disc face, referred as a focusing direction F, and a direction parallel to the disc face, referred as a tracking direction T, as shown in FIG. 2.

Referring to FIG. 3, a conventional tracking control system 1 of an optical disc drive is schematically shown. The optical disc 110 is driven to rotate by a spindle motor 120. For reading data from the rotating disc, the optical pickup head 10 is driven to move in the tracking direction T by a sled motor 130 to perform a seeking operation. Further, the optical pickup head 10 is driven to move in the tracking direction T by a tracking coil 140 to perform a tracking operation. The term “tracking operation” used herein means that the position of the optical pickup head with respect to a selected track is maintained in the proper center position above the selected track. The term “seeking operation” means that the optical pickup head jumps from one track to another track. When an electronic signal is generated responsive to the optical signal reflected from the optical disc 110 and received by the optical pickup head 10, the electronic signal is transmitted to a radio frequency (RF) amplifier 150 to be processed into a radio frequency signal RF and a tracking error signal TE. The radio frequency signal RF and the tracking error signal TE are further processed by a digital signal processor (DSP) 170 to generate two control signals TRO and FMO. In response to the control signals FMO and TRO, a motor actuator 160 makes adjustments to output driving forces for driving the sled motor 130 and the tracking coil 140, thereby properly locating the optical pickup head 10 onto the desired track. For example, the control signal TRO facilitates tracking control of the tracking coil 140 by way of the motor actuator 160.

In generally, the amplitude of the tracking error signal TE represents the tracking error amount of the optical pickup head 10. The tracking error signal TE is controlled by the closed-loop control system including the optical pickup head 10, the radio frequency (RF) amplifier 150, the digital signal processor (DSP) 170, the motor actuator 160 and the tracking coil 140. In response to the tracking error signal TE, the control signal TRO is adjusted by the digital signal processor (DSP) 170 so as to precisely locate the optical pickup head 10 onto the desired track.

Conventionally, a gain adjusting operation of the initial tracking error signal TE is required by the digital signal processor (DSP) 170 for the closed-loop control mechanism. The gain-adjusted tracking error signal TE′ (TE′=TE×A, where A is the gain) is then transmitted to the digital signal processor (DSP) 170 for processing. Generally, the sensitivity of the optical pickup head 10 is increased with the increase of the gain A. The functional circuit for performing such gain adjusting operation can be an independent device (not shown) or incorporated into the frequency (RF) amplifier 150 or the digital signal processor (DSP) 170.

Since the sensitivity of the optical pickup head 10 varies with the gain A and the initial tracking error signal TE for the data region 1101 is different from that for the blank region 1102 in intensity due to the difference in optical features between the two regions, in order to obtain comparable intensities of the gain-adjusted tracking error signal TE′ for both regions, a gain value A1 is used when the optical pickup head 10 reads the data region 1101 while another gain value A2 is used when the optical pickup head 10 reads the blank region 1102. In the prior art, the ratio of A2 to A1 is set to be a constant value, for example 1.5. It is apparent that the constant ratio cannot reflect respective optical features of various optical discs so that the tracking control and data-reading procedure cannot be performed in an optimum manner.

### SUMMARY OF THE INVENTION

The present invention provides a method for generating a tracking error signal dynamically adjusted with different gains for different regions of a disc so as to improve tracking control and data-reading quality.

In accordance with a first aspect, there is provided a method for generating a gain-adjusted tracking error signal in a disc reading apparatus. Firstly, a disc having been defined with a data region and a blank region is loaded into the disc reading apparatus. Then, a start-up procedure is executed, and a seeking operation across an interface between the data region and the blank region is performed to detect first and second voltage peaks of a first tracking error signal for the data region and the blank region, respectively. After the start-up procedure has been completed, the disc reading apparatus enters a ready-to-read state. In the ready-to-read state, a tracking operation is performed to generate a second tracking error signal and the second tracking error signal is adjusted with a first gain and a second gain for the data region and the blank region, respectively, thereby generating the gain-adjusted tracking error signal. Specifically, the ratio of the first gain to the second gain is equal to the ratio of the second voltage peak to the first voltage peak.

In an embodiment, the data region of the disc is previously written therein data to be read, and the blank region of the disc has not been recorded any data therein.

In an embodiment, the first and second voltage peaks are detected by performing an analog-to-digital conversion operation of the first tracking error signal and performing comparison operations of voltages of the first tracking error signal to realize respective peak values of the first tracking error signal resulting from the data region and the blank region as the first and second voltage peaks.

In an embodiment, the method further comprises a step of storing the ratio of the second voltage peak to the first voltage peak into a data register.

In an embodiment, the first gain is equal to the ratio of the second voltage peak to the first voltage peak, and the second gain is equal to 1.

In an embodiment, the disc and the disc reading apparatus are an optical disc and an optical disc drive, respectively.

In accordance with a second aspect, there is provided a method for generating a gain-adjusted tracking error signal in a disc reading apparatus. Firstly, a disc having been defined with a data region and a blank region is loaded into the disc reading apparatus. Then, a start-up procedure is executed, a seeking operation across an interface between the data region and the blank region is performed, and voltages of the first tracking error signal are compared so as to determine first and second voltage peaks for the data region and the blank region, respectively. After the start-up procedure has been completed, the disc reading apparatus enters a ready-to-read state. In the ready-to-read state, a tracking operation is performed to generate a second tracking error signal, and the second tracking error signal is adjusted with a gain, thereby generating the gain-adjusted tracking error signal. Specifically, the gain correlates to the ratio of the second voltage peak to the first voltage peak.

In an embodiment, the ratio of the second voltage peak to the first voltage peak is used subsequently as the gain to adjust the second tracking error signal.

In accordance with a third aspect, there is provided a method for generating a gain-adjusted tracking error signal in a disc reading apparatus. Firstly, a disc having been defined with a data region and a blank region is loaded into the disc reading apparatus. Then, an open-loop seeking operation is performed to generate a first tracking error signal, and voltages of the first tracking error signal are compared so as to determine first and second voltage peaks for the data region and the blank region, respectively. Then, a closed-loop tracking operation is performed to generate a second tracking error signal, and the second tracking error signal resulting from the data region and the blank region are differentially adjusted according to the first and second voltage peaks, thereby generating the gain-adjusted tracking error signal.

In an embodiment, the first and second voltage peaks are detected by moving a data pickup head of the disc reading apparatus across an interface between the data region and the blank region and performing an analog-to-digital conversion operation of the first tracking error signal and performing comparison operations of voltages of the first tracking error signal to realize respective peak values of the first tracking error signal resulting from the data region and the blank region as the first and second voltage peaks.

In an embodiment, the second tracking error signal is differentially adjusted with a first gain and a second gain for the data region and the blank region, respectively.

In an embodiment, the closed-loop tracking operation is performed in a ready-to-read state of the disc reading apparatus.

In an embodiment, the disc and the disc reading apparatus are an optical disc and an optical disc drive, respectively.

The contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view of a disc having been defined with a data region and a blank region;

FIG. 2 is a schematic diagram illustrating a typical optical pickup head;

FIG. 3 is a functional block diagram illustrating a conventional tracking control system of a disc drive;

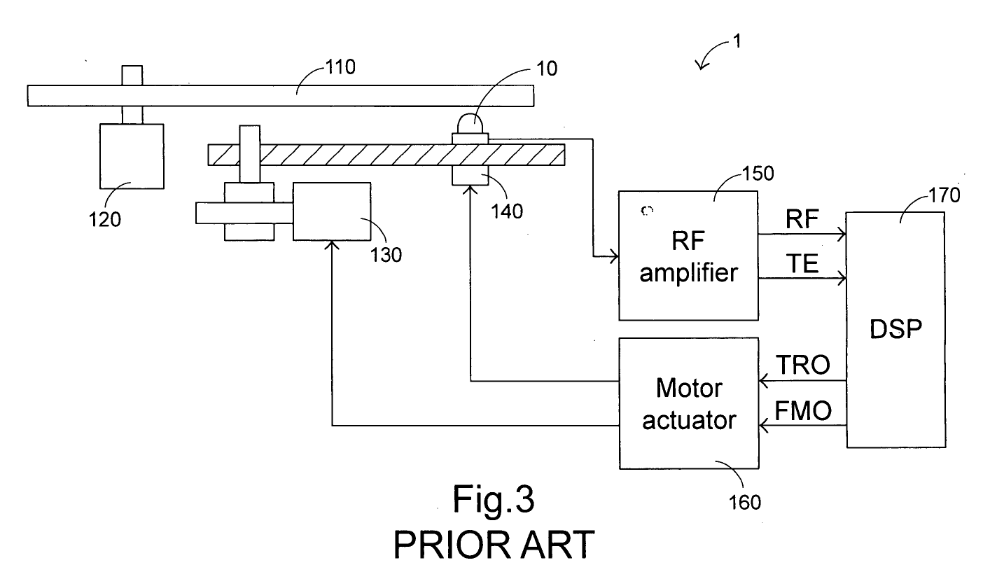

FIG. 4 is a functional block diagram illustrating a tracking control system of a disc drive according to a preferred embodiment of the present invention; and

FIG. 5 is a waveform diagram illustrating an initial tracking error signal TE resulting from the data region and the blank region of a disc during a start-up procedure.

### DETAILED DESCRIPTION OF THE PREFERRED EMBODIMENT

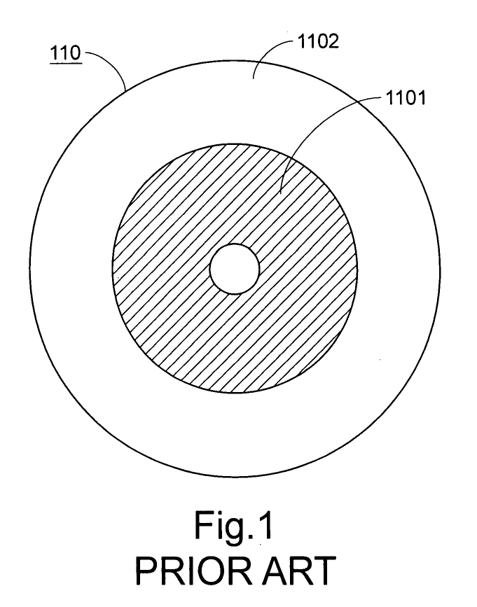

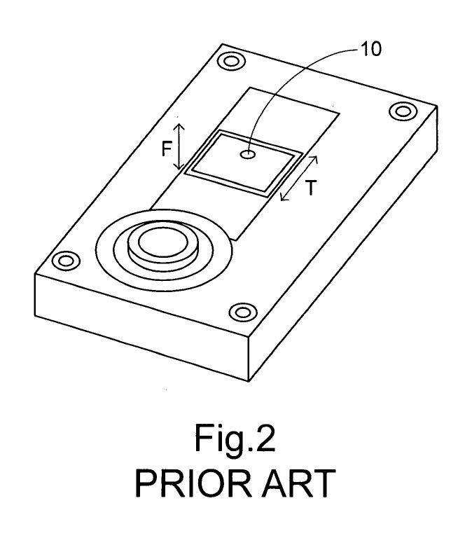

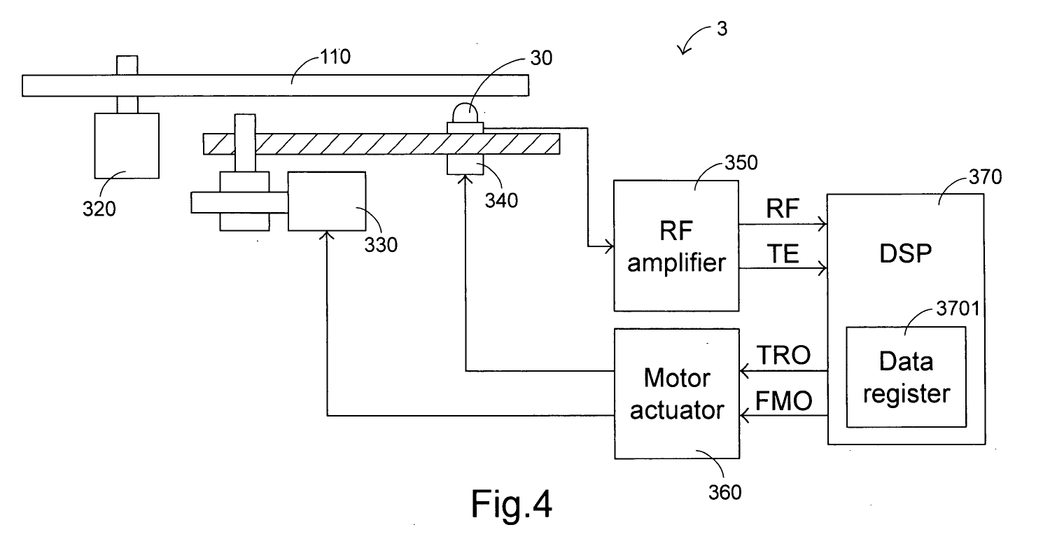

Referring to FIG. 4, a tracking control system according to a preferred embodiment of the present invention is schematically shown. The tracking control system 3 principally comprises an optical pickup head 30, a radio frequency (RF) amplifier 350, a digital signal processor (DSP) 370 and a motor actuator 360. For reading data from an optical disc having been recorded therein data, for example the optical disc 110 which has been defined with a data region 1101 and a blank region 1102, as shown in FIG. 1, a spindle motor 320 is used to rotate the disc, and the optical pickup head 30 is driven to move in the tracking direction T (see FIG. 2) by a sled motor 330 to perform an open-loop seeking operation. Further, the optical pickup head 30 is driven to move in the tracking direction T by a tracking coil 340 to perform a closed-loop tracking operation. When an electronic signal is generated responsive to the optical signal reflected from the optical disc 310 and received by the optical pickup head 30, the electronic signal is transmitted to the radio frequency (RF) amplifier 350 to be processed into a radio frequency signal RF and a tracking error signal TE. The radio frequency signal RF and the tracking error signal TE are further processed by the DSP 370 to generate two control signals TRO and FMO. In response to the control signals FMO and TRO, the motor actuator 360 makes adjustments to output driving forces for driving the sled motor 330 and the tracking coil 340, thereby properly locating the optical pickup head 30 onto the desired track. For example, the control signal TRO facilitates tracking control of the tracking coil 340 by way of the motor actuator 360.

As previously described, the initial tracking error signal TE for the data region 1101 is different from that for the blank region 1102 in intensity. Therefore, the tracking error signal TE is preferably adjusted with different gains for different regions to result in a gain-adjusted tracking error signal TE′ that has intensities in similar order. According to the present invention, the gains used for adjusting the tracking error signal are dynamically adjusted according to the features of the disc loaded in the disc reading apparatus. The functional block diagram of the tracking control system of the disc reading apparatus, which is for example an optical disc drive, according to an embodiment of the present invention is illustrated with reference to FIG. 4.

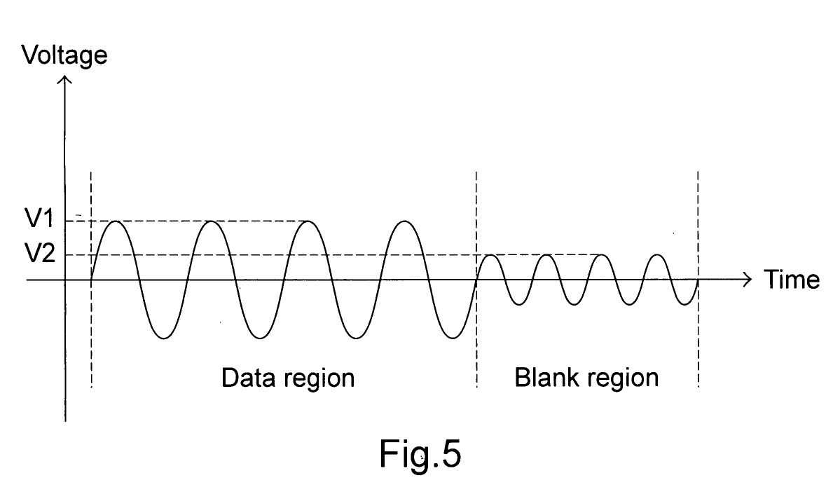

After an optical disc is loaded into the optical disc drive, a start-up procedure is entered. In the start-up procedure, the closed-loop tracking operation of the tracking control system 3 is disabled, and a seeking operation is performed to move the optical pickup head 30 through both the data region and the blank region of the disc. Meanwhile, an initial tracking error signal TE is generated from the RF amplifier 350. While the optical pickup head 30 is moving across the interface between the data region and the blank region, the amplitude of the tracking error signal TE decreases, as shown in FIG. 5. For leveling the intensities of the two regions, gain-adjustment is performed for the tracking error signal TE as described below. The tracking error signal TE is first processed with an analog-to-digital conversion operation. Then, voltages of the tracking error signal TE are compared to realize respective peak values of the tracking error signal TE resulting from the data region and the blank region. Accordingly, first and second voltage peaks V1 and V2 are realized. The ratio data (V2/V1) of the second voltage peak V2 to the first voltage peak V1 is then stored into a data register 3701 included in the DSP 370 for gain-adjusting use.

After the start-up procedure has completed, a ready-to-read state is entered. In the ready-to-read state, a gain-adjusting operation of the tracking error signal TE is done with the closed-loop control mechanism while reading the disc. When the optical pickup head 30 reads the data region where data have been previously written, a relatively small gain value A1 is used in the gain-adjusting operation to generate a gain-adjusted tracking error signal TE′ corresponding to the data region. On the other hand, when the optical pickup head 30 reads the blank region where only essential information is recorded and no data is written, a relatively large gain value A2 is used for gain adjustment to generate the gain-adjusted tracking error signal TE′ corresponding to the blank region. According to an embodiment of the present invention, the gain values A1 and A2 are made to correlate to each other and further correlate to the voltage peaks V1 and V2. For example, the gain ratio A1/A2 is equal to the voltage peak ratio V2/V1. More specifically, the gain value A1 can be equal to the voltage peak ratio V2/V1 and the gain value A2 equals to unity (1).

Since the gain-adjusted tracking error signal TE′ is obtained by differentially adjusting the tracking error signal resulting from the data region and the blank region, comparable intensities thereof for both regions can be obtained. Further, by making the gain ratio A1/A2 equal to the voltage peak ratio V2/V1, the gain adjustment is dynamic and can properly reflect respective optical features of different disc loaded into the disc reading apparatus so as to improve tracking control and data-reading quality.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A method for generating a gain-adjusted tracking error signal in a disc reading apparatus, comprising steps of:
loading a disc into the disc reading apparatus, said disc having been defined with a data region and a blank region;
executing a start-up procedure and performing a seeking operation across an interface between said data region and said blank region to detect first and second voltage peaks of a first tracking error signal for said data region and said blank region, respectively; and
entering a ready-to-read state after said start-up procedure has been completed, and in said read-to-read state, performing a tracking operation to generate a second tracking error signal and adjusting said second tracking error signal with a first gain and a second gain for said data region and said blank region, respectively, thereby generating said gain-adjusted tracking error signal, wherein the ratio of said first gain to said second gain is equal to the ratio of said second voltage peak to said first voltage peak.

2. The method according to claim 1 wherein said data region of said disc is previously written therein data to be read, and said blank region of said disc has not been recorded any data therein.

3. The method according to claim 1 wherein said first and second voltage peaks are detected by performing an analog-to-digital conversion operation of said first tracking error signal and performing comparison operations of voltages of said first tracking error signal to realize respective peak values of said first tracking error signal resulting from said data region and said blank region as said first and second voltage peaks.

4. The method according to claim 1 further comprising a step of storing the ratio of said second voltage peak to said first voltage peak into a data register.

5. The method according to claim 1 wherein said first gain is equal to the ratio of said second voltage peak to said first voltage peak, and said second gain is equal to 1.

6. The method according to claim 1 wherein said disc and said disc reading apparatus are an optical disc and an optical disc drive, respectively.

7. A method for generating a gain-adjusted tracking error signal in a disc reading apparatus, comprising steps of:
loading a disc into the disc reading apparatus, said disc having been defined with a data region and a blank region;
executing a start-up procedure and performing a seeking operation across an interface between said data region and said blank region, and comparing voltages of said first tracking error signal to determine first and second voltage peaks for said data region and said blank region, respectively; and
entering a ready-to-read state after said start-up procedure has been completed, and in said read-to-read state, performing a tracking operation to generate a second tracking error signal and adjusting said second tracking error signal with a gain, thereby generating said gain-adjusted tracking error signal, wherein said gain correlates to the ratio of said second voltage peak to said first voltage peak.

8. The method according to claim 7 wherein said data region of said disc is previously written therein data to be read, and said blank region of said disc has not been recorded any data therein.

9. The method according to claim 7 wherein said first and second voltage peaks are detected by performing an analog-to-digital conversion operation of said first tracking error signal and performing comparison operations of voltages of said first tracking error signal to realize respective peak values of said first tracking error signal resulting from said data region and said blank region as said first and second voltage peaks.

10. The method according to claim 7 further comprising a step of storing the ratio of said second voltage peak to said first voltage peak into a data register, wherein the ratio of said second Voltage peak to said first voltage peak is used subsequently as said gain to adjust said second tracking error signal.

11. The method according to claim 7 wherein said disc and said disc reading apparatus are an optical disc and an optical disc drive, respectively.

12. A method for generating a gain-adjusted tracking error signal in a disc reading apparatus, comprising steps of:
loading a disc into the disc reading apparatus, said disc having been defined with a data region and a blank region;
performing an open-loop seeking operation to generate a first tracking error signal and comparing voltages of said first tracking error signal to determine first and second voltage peaks for said data region and said blank region, respectively; and
performing a closed-loop tracking operation to generate a second tracking error signal and differentially adjusting said second tracking error signal resulting from said data region and said blank region according to said first and second voltage peaks, thereby generating said gain-adjusted tracking error signal.

13. The method according to claim 12 wherein said data region of said disc is previously written therein data to be read, and said blank region of said disc has not been recorded any data therein.

14. The method according to claim 12 wherein said first and second voltage peaks are detected by moving a data pickup head of said disc reading apparatus across an interface between said data region and said blank region and performing an analog-to-digital conversion operation of said first tracking error signal and performing comparison operations of voltages of said first tracking error signal to realize respective peak values of said first tracking error signal resulting from said data region and said blank region as said first and second voltage peaks.

15. The method according to claim 12 wherein said second tracking error signal is differentially adjusted with a first gain and a second gain for said data region and said blank region, respectively.

16. The method according to claim 15 wherein the ratio of said first gain to said second gain is equal to the ratio of said second voltage peak to said first voltage peak.

17. The method according to claim 15 wherein said first gain is equal to the ratio of said second voltage peak to said first voltage peak, and said second gain is equal to 1.

18. The method according to claim 15 further comprising a step of storing the ratio of said second voltage peak to said first voltage peak into a data register.

19. The method according to claim 12 wherein said open-loop seeking operation is performed during a start-up procedure of said disc reading apparatus.

20. The method according to claim 12 wherein said closed-loop tracking operation is performed in a ready-to-read state of said disc reading apparatus.
